(19) United States
(12) Patent Application Publication
(10) Pub. No.: US 2014/0197624 A1
(43) Pub. Date: Jul. 17, 2014

(54) Write & Wipe Pad

(71) Applicant: Bhushan Lele, Clearwater, FL (US)

(72) Inventor: Bhushan Lele, Clearwater, FL (US)

(21) Appl. No.: 13/739,047

(22) Filed: Jan. 11, 2013

(51) Int. Cl. B42D 1/00

(52) U.S. Cl. CPC B42D 1/008
USPC 281/39

(57) ABSTRACT

The Write & Wipe Pad is a specially designed notepad that has 5 dry erase pages bound into the notepad & is perforated. Underneath the dry erase pages are 45 regular ruled paper sheets as expected in a normal notepad. All sheets have 3 holes on both the left and right margin, so they can be torn away from the note pad and placed in to 3 ring-binder in left hand side position or right hand side position.
The Top 5 Sheets are Dry Erase sheets: 190 gsm white card with lamination.
Notepad Sheets Material: 60 gsm wood free paper inner pages.
Back support: (fits into any standard Padfolio) 600 gsm cardboard.
Size: 28.8×20.9 cm
Each side: 3 holes, diameter 7 mm

### BACKGROUND OF THE INVENTION

After inventing a multi-paged, portable whiteboard, I thought about making the dry erase functionality even more accessible by putting it into a regular notepad. In this way, people can carry around the write and wipe notepad instead of the normal notepad, using the regular lined paper as they normally do, but also having the choice to use the dry erase functionality that is more common in whiteboards. Dry erase paper already exists, and so we figured out a way to bind the dry erase sheets into a regular notepad.

### BRIEF SUMMARY OF THE INVENTION

There are two worlds out there—the notebook world and the whiteboard world. Some people swear by the convenience and intimacy of a notebook, while other people swear by the thinking and organizational power of a nice sized whiteboard. Both mediums have their advantages, but a whiteboard is not always easy to find on hand. Now, you have the advantage of having a multi-page, dry erase medium at your fingertips. The dry erase surface is perfect for writing down a quick note that you are going to throw away later. It saves paper. Its also a handy brainstorming, thinking, and organizational tool without having to find a whiteboard. The notepad also has 45 regular sheets of lined paper so it gives the functionality of a normal notepad. The ‘Write and Wipe’ notepad has been designed to fit into any standard size padfolio binder.

### BRIEF DESCRIPTION OF THE SEVERAL VIEWS OF THE DRAWING

FIG. 1a.

Five sheets of dry erase paper perforated and bound to the notepad.

Specifications of Pad:
The top five Sheets are Dry Erase sheets: 190 gsm white card with lamination.
Sheets Material: 60 gsm wood free paper inner pages.
Back support: 600 gsm cardboard.
Size: 28.8×20.9 cm
Each side: 3 holes, diameter 7 mm.

FIG. 1b.

Below the dry erase sheets is a standard size ruled notepad.

FIG. 1c.

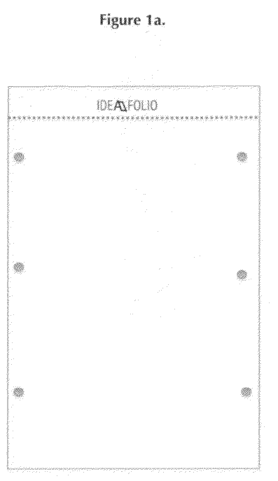

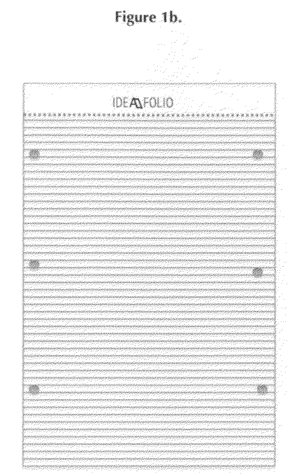

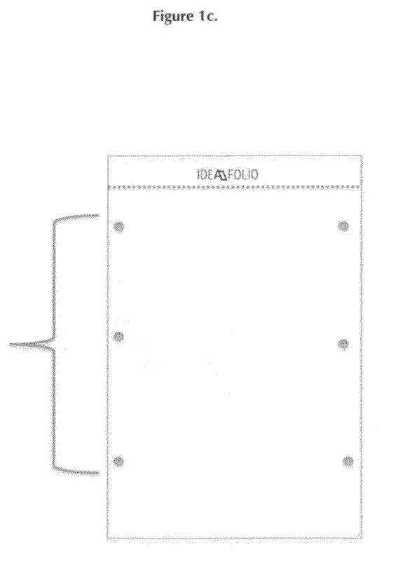

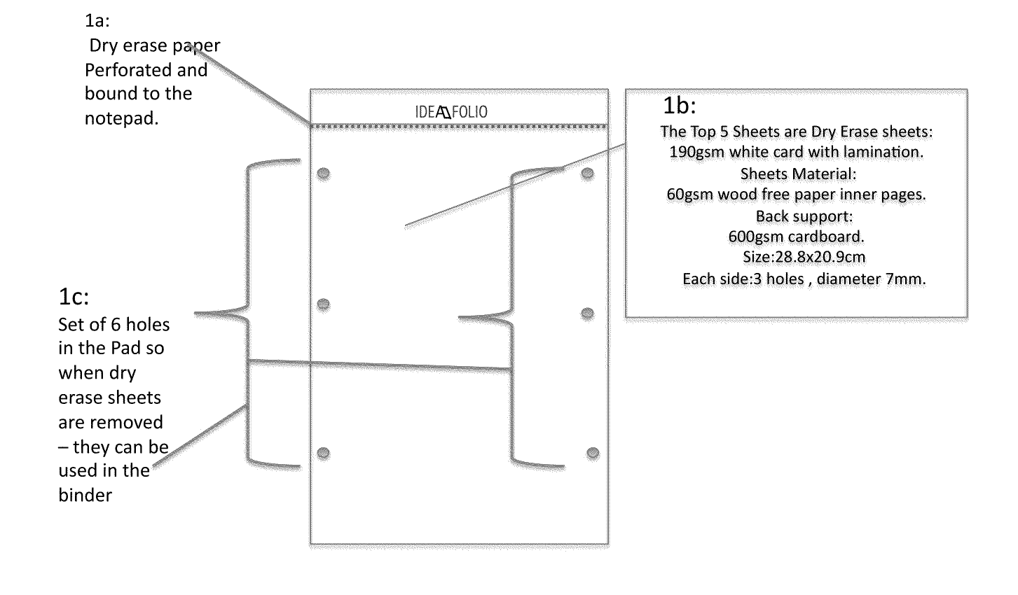

Set of 6 holes in the Pad—three on each side, so when dry erase sheets are removed—they can be used in the binder in left hand position or right hand position.

### DETAILED DESCRIPTION OF THE INVENTION

The Write & Wipe Pad is a specially designed notepad that has 5 dry erase pages bound into the notepad & is perforated. Underneath the dry erase pages are 45 regular lined paper sheets as expected in a regular ruled notepad. All sheets have 3 holes on both the left and right margin, so they can be torn away from the notepad and placed in to a 3 ring binder in left hand side position or right hand side position.
The top 5 Sheets are Dry Erase sheets: 190 gsm white card with lamination.
Notepad Sheets Material: 60 gsm wood free paper inner pages.
Back support: (fits into any standard Padfolio)
600 gsm cardboard. Size: 28.8×20.9 cm
Each side: 3 holes, diameter 7 mm

1. Perforated dry erase sheets bound into a standard size ruled notepad.
